(19) United States
(12) Patent Application Publication
(10) Pub. No.: US 2010/0286854 A1
(43) Pub. Date: Nov. 11, 2010

(54) DRIVING APPARATUS FOR IMPROVING VEHICLE FUEL EFFICIENCY

(76) Inventors: Ten-Lee CHANG, Taipei (TW); Tien-Li CHEN, Taipei (TW)

Correspondence Address: Muncy, Geissler, Olds & Lowe, PLLC, 4000 Legato Road, Suite 310, FAIRFAX, VA, 22033, US

(21) Appl. No.: 12/437,102

(22) Filed: May 7, 2009

(51) Int. Cl. B60W 20/00

(52) U.S. Cl. 701/22; 903/930

(57) ABSTRACT

A driving apparatus for improving fuel efficiency of vehicle is provided. The driving apparatus includes an engine connected to a transmission system of the vehicle; a clutch connected to the engine for power engaging or disengaging with the engine; a generator connected to the clutch for power engaging or disengaging with the clutch; a control circuit electrically connected to the clutch and the generator; and a battery electrically connected to the control circuit, wherein when the engine is operating, the control circuit receives a signal to allow the battery to provide power to drive the generator; when the rotation speed of the generator reaches a threshold, the control circuit is activated to drive the clutch to engage the engine and the generator, interrupt power provided to drive the generator so that the generator is operated by the engine, and the generated power is stored through the control circuit to the battery.

### BACKGROUND OF THE INVENTION

1. Field of the Invention

The present invention generally relates to an apparatus for improving the fuel efficiency of conventional gasoline and diesel engines used in transportation vehicles.

2. The Prior Arts

The rapid development of automobile industry in recent years has greatly shortened the commuting time. However, the carbon-dioxide from the use of the gasoline has led to the global warming and poor air quality. It is estimated that only about 30% of the fuel used by the car engine is for moving the car, while the remaining 70% is transformed into heat, and wasted through the heat dissipation system and the exhaustion system. Facing the increasing pressure of the global warming and the pending shortage of oil supply, it is imperative to revise the technology and the use habit to improve the fuel efficiency, especially for the auto industry. According to a report from Discovery Channel, the oil consumption in USA is about ¼ of the global consumption, and 55% of that amount is consumed by the 230 million cars. Based on that ration, it is roughly estimated that about half of oil is used by cars.

However, the new models based on the new fuel technology, such as, electrical-gas hybrid cars, make up a very small share in the market. The conventional gas/diesel engine cars are still the mainstream of the automobile industry. Therefore, the overall energy consumption by the cars still leaves large room for improvement.

One of the reasons that the conventional engine consumes so much fuel is the structure of the driving apparatus. As shown in FIG. 1, a conventional driving apparatus of a car is to install two co-axial sets of active belt wheels 11, 12, 13 on the crank shaft of an engine 1. An active belt wheel 11 uses a belt A to couple a passive belt wheel 511 located at a compressor 51 of an air-conditioning system 5. Another active belt wheel 12 uses a belt B to couple with a passive belt wheel 31 located at a generator 3. Yet another active belt wheel 13 uses a belt C to couple with a passive belt wheel 9A2 connected to a first cooling fan 9A1 and located at an engine cooling water tank system 14. In addition, the air-conditioning system also includes a second cooling fan 9B1 connected to a second fan motor 9B, close to a compressor cooling system 52, and the second fan motor 9B is directly powered by a battery. When the engine 1 is started, regardless of the air-conditioner being in use or not, the compressor 51 must be driven to rotate. Besides, regardless of the battery 8 being fully charged or not, the engine 1 must drive the generator 3 to charge the battery 8. Similarly, even when the temperature of the engine cooling water tank system is under the threshold, the first cooling fan 9A1 must be driven by the belt C to rotate. All the above activities lead to the overloading of the engine, the direct increase in fuel consumption and lowering the fuel efficiency.

### SUMMARY OF THE INVENTION

The present invention has been made to overcome the above-mentioned drawback of the structure of conventional driving apparatus of cars.

A primary feature of the present invention is to avoid a direct engagement of an engine and a generator. Instead, a clutch is placed between the engine and the generator. A control circuit is also provided. When the engine is in operation, the detection system makes the control circuit to receive a specific signal, so that the battery provides the power to drive the generator. When the generator rotates to a threshold angular speed, the control circuit is activated to drive the clutch to engage the engine and the generator and interrupt the power provided to the generator. At this point, the engine drives the generator, and the power generated by the generator can be used by the electrical devices of the car as well as stored in the battery through the control circuit.

Another feature of the present invention is to avoid a direct engagement of an engine and a compressor. Instead, the compressor is connected to a motor, and a control circuit is used to control the activation of the motor. When the air-conditioner is not in use, no electricity is provided to the motor for driving the compressor. When the air-conditioner is turned on, the control circuit provides electricity to the motor to drive the compressor to operate the air-conditioning system.

Yet another feature of the present invention is to avoid a direct engagement of an engine and a first cooling fan for cooling an engine cooling water tank system. Instead, the first cooling fan is connected to a first cooling fan motor, and the first cooling fan motor is controlled by a control circuit according to the temperature of the engine cooling water tank system. The control circuit further controls rotation speed of the first cooling fan motor according to the temperature of the engine cooling water tank system. Besides, the control circuit can also determine the rotation speed of a second cooling fan motor according to the detected temperature of the compressor cooling system to save the electricity during the motor operation.

According to the above features, the present invention provides an engine, connected to the vehicle's transmission system; a clutch, connected to the engine; a generator, connected to the clutch; a control circuit, electrically connected to the clutch; and a battery, electrically connected to the control circuit. The clutch can engage or disengage the crank shaft of the engine and the center shaft of the generator. The control circuit is designed to receive a signal, when the engine is operating, to make the battery to provide the power to drive the generator. When the rotation speed of the generator reaches a threshold, the control circuit is activated to drive the clutch to engage the engine and the generator, and interrupt the battery power to the generator so that the generator is completely driven by the engine.

The threshold rotation speed of the generator to activate the control circuit of the present invention is when the rotation angular speed of the rotor of the generator is the same as the angular speed of the engine. At this point, a signal is issued by the detection system to the control circuit to drive the clutch.

The control circuit of the present invention, when detecting a signal indicating that the battery is lower than a threshold, automatically switches the circuit for the battery to supply power to drive the generator.

The present invention also provides an air-conditioning system with a compressor, and a motor connected to the compressor. The motor is also connected to the aforementioned control circuit. The control circuit uses a switch to directly control whether the battery provides the power to the motor. Only when the motor is driven, the compressor will operate. Otherwise, the compressor stays in idle to reduce the engine load.

The present invention also provides a first cooling fan motor and a second cooling fan motor, electrically connected to the aforementioned control circuit respectively; and a first temperature sensor, located at the engine cooling water tank system; and a second temperature sensor, located at the compressor cooling system. When the temperature of the engine cooling water tank system sensed by the first temperature sensor and the temperature of the compressor cooling system sensed by the second temperature sensor are lower than a threshold, the control circuit will not drive the first cooling fan motor and the second cooling fan motor. Otherwise, the control circuit will drive the first cooling fan motor and the second cooling fan motor.

The application of the driving apparatus of the present invention is not limited to new cars, but also the existing old cars. The fuel efficiency can be improved as high as 30%. In other wise, if the present invention is applied to all the vehicles, the fuel consumption can be reduced as much as 15% globally.

The foregoing and other objectives, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional driving apparatus for vehicles;

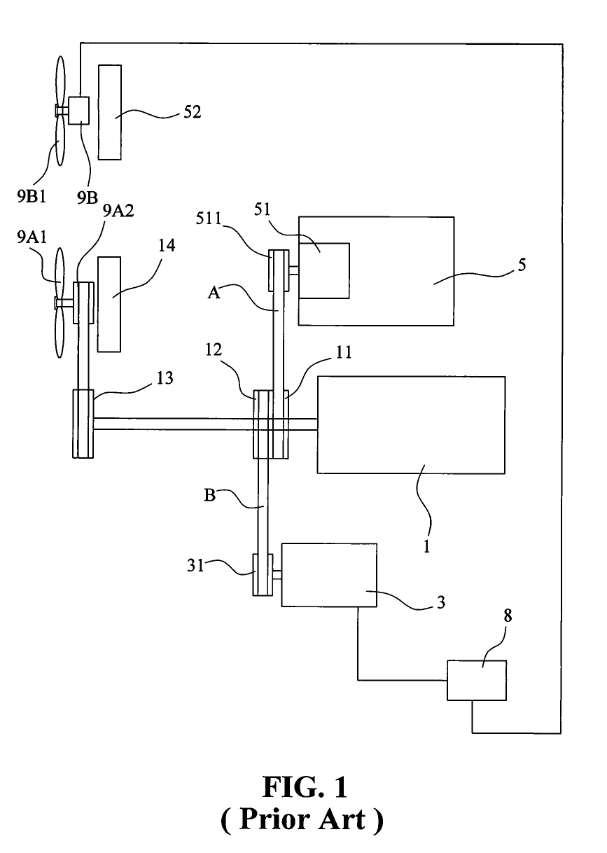

FIG. 2 shows a schematic view of a driving apparatus according to a first embodiment of the present invention;

FIG. 3 shows a schematic view of the clutch prior the operation to engage the generator and engine according to the present invention;

FIG. 4 shows a schematic view of the clutch after the operation to engage the generator and engine according to the present invention;

FIG. 5 shows a schematic view of a driving apparatus for improving fuel efficiency according to a second embodiment of the present invention; and

FIG. 6 shows a schematic view of a driving apparatus for improving fuel efficiency according to a third embodiment of the present invention.

### DETAILED DESCRIPTION OF THE PREFERRED EMBODIMENT

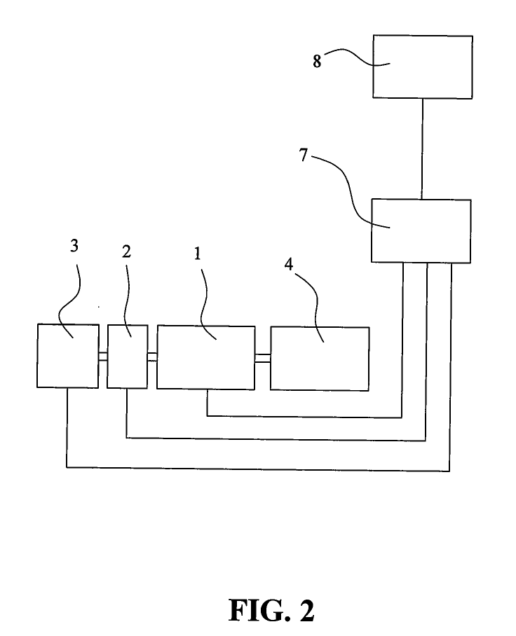

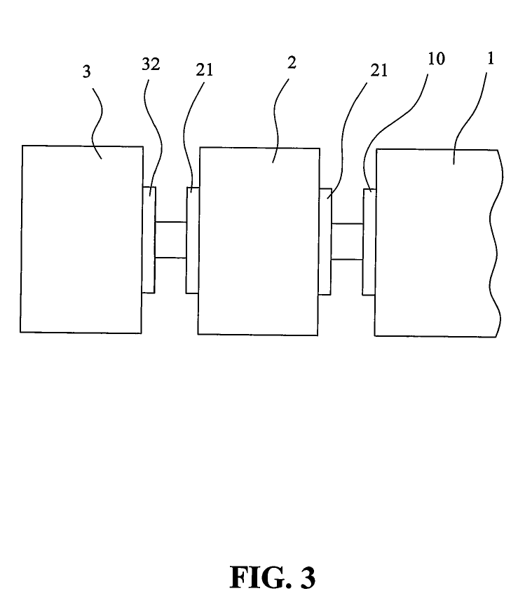

FIG. 2 shows a driving apparatus for improving fuel efficiency according to a first embodiment of the present invention. The driving apparatus includes an engine 1, with a crank shaft 10 (refer to FIG. 3) connected to a transmission system 4. When the engine 1 operates, the power is propagated through the crank shaft 10 to the transmission system 4 to move the vehicle. The other side of the engine opposite to the transmission system 4 is co-axially with the crank shaft 10 engaged to a clutch 2. The Clutch 2 is co-axially engaged to a rotor 32 (refer to FIG. 3) of a generator 3. The present invention further provides a control circuit 7. The control circuit 7 is electrically connected to the clutch 2 and the generator 3. The control circuit 7 is electrically connected to a battery 8 of the vehicle.

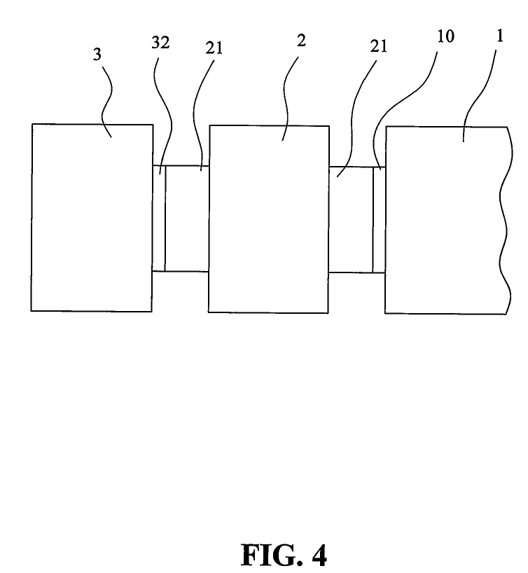

The operation of the driving apparatus of the present invention is that when the engine 1 is in operation condition, the control circuit 7 receives a signal to enable the battery 8 to provide power to drive the generator 3. When the rotation speed of the generator 3 reaches a threshold, a signal is fed back to the control circuit 7 so that the control circuit 7 will drive the clutch 2 to engage connecting elements 21 on both sides of the clutch 2 to the crank shaft 10 of the engine 1 and the rotor 32 of the generator 3 simultaneously (refer to FIG. 4). Then, the control circuit 7 interrupts the power supplied to the generator 3, and allows the generator 3 to be completely driven by the engine 1 to avoid consuming power in the battery. The power generated by the generator 3 is then fed by the control circuit 7 to be stored in the battery 8.

In the preferred embodiment of the present invention, a power capacity detector is included in the control circuit 7. When the power capacity detector detects a signal indicating that the power stored in the battery 8 is lower than a threshold, the control circuit 7 switches for the battery 8 to provide power to drive the generator 3 in order to charge the battery 8 in time. The aforementioned threshold for power capacity must be sufficient for activating the generator 3.

The threshold for the rotation speed of the generator 3 is when the angular speed of the rotor 32 is close or the same as the angular speed of the crank shaft 10 of the engine 1. The purpose of this is that when the rotor 32 has the same angular speed as the crank shaft 10, the connecting elements 21 on both sides of the clutch 2 can smoothly engage the rotor 32 and the crank shaft 10.

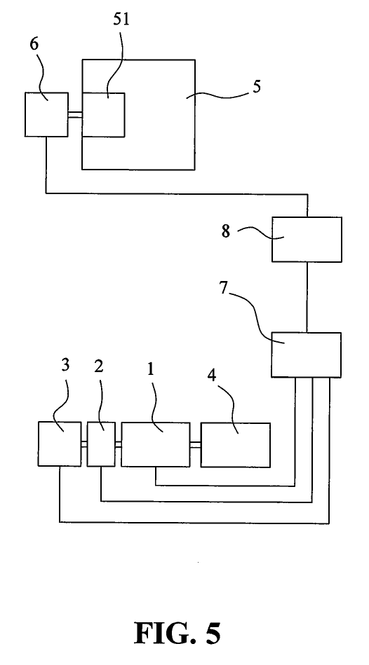

FIG. 5 shows a second embodiment of the present invention, based on the apparatus of FIG. 2, further including an air-conditioning system 5 with a compressor 51, and a motor 6 connected to the rotational shaft of the compressor 51. The motor 6 is electrically connected to the control circuit 7, and the control circuit 7 includes a switch (not shown). When the user uses the air-conditioner, the switch is turned on to let the battery 8 provide power through the control circuit 7 to the motor 6. After the motor starts to rotate, the motor drives the compressor 51 directly to operate the air-conditioning system 5. When the air-conditioning is no longer needed, the switch is switched off without the engine to continue operating the compressor.

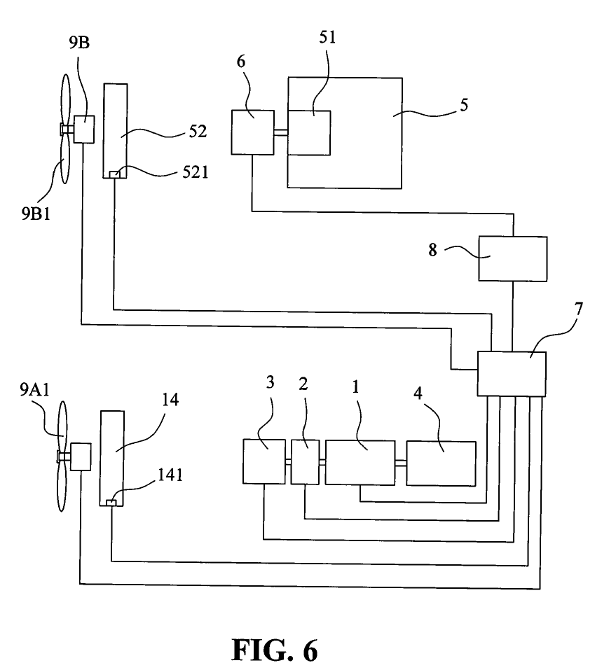

FIG. 6 shows a third embodiment of the present invention, based on the apparatus of FIG. 5, further including a first cooling fan motor 9A connected to a first cooling fan 9A1, and a second cooling fan motor 9B connected to a second cooling fan 9B1. Both of the first cooling fan motor 9A and the second cooling fan motor 9B are electrically connected to the control circuit 7. An engine cooling water tank system 14 for providing the engine cooling system includes a first temperature sensor 141, and the first temperature sensor 141 is electrically connected to the control circuit 7. A compressor cooling system 52 for cooling the compressor includes a second temperature sensor 521, and the second temperature sensor 521 is electrically connected to the control circuit 7. When the car is just started, or when the car is running at high speed and the airflow is high so that the temperature sensed by the first temperature sensor 141 is lower than a threshold, the control circuit 7 does not activate the first cooling fan motor 9A. Otherwise, the control circuit 7 activates the first cooling fan motor 9A to dissipate the heat absorbed by the engine cooling water tank system 14. In addition, when the air-conditioning system is not activated or just started so that the temperature of the compressor cooling system 52 sensed by the second temperature sensor 521 is lower than a threshold, the control circuit 7 does not activate the second cooling fan motor 9B. After the air-conditioning system operates for a duration and the temperature increases in the compressor cooling system and sensed by the second temperature sensor 521, the control circuit 7 activates the second cooling fan motor 9B to dissipate the heat absorbed by the compressor cooling system 52. Furthermore, the control circuit 7 of the present invention can be also designed to adjust the rotation speed of the first cooling fan motor and the second cooling fan motor respectively according to the temperature of the engine cooling water tank system sensed by the first temperature sensor and the temperature of the compressor cooling system sensed by the second temperature sensor.

In summary, the present invention is to reduce the dependence of the compressor and the generator on the engine so as to lower the load on the engine to achieve the objective of fuel consumption as well as improve the fuel efficiency.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A driving apparatus for improving fuel efficiency of a vehicle, comprising:
an engine, connected to a transmission system of the vehicle;
a clutch, connected to the engine, for power engaging or disengaging with the engine;
a generator, connected to the clutch, for power engaging or disengaging with the clutch;
a control circuit, electrically connected to the clutch and the generator; and
a battery, electrically connected to the control circuit;
wherein when the engine is operating, the control circuit receives a signal to allow the battery to provide power to drive the generator; when the rotation speed of the generator reaches a threshold, the control circuit is activated to drive the clutch to engage the engine and the generator, interrupt power provided to drive the generator so that the generator is operated by the engine, and the generated power is stored through the control circuit to the battery.

2. The driving apparatus as claimed in claim 1, further comprising:
an air-conditioning system with a compressor; and
a motor, connected to the compressor, the motor being electrically connected to the control circuit;
wherein the control circuit enables the battery to provide power to drive the motor so that the compressor rotates to activate the air-conditioning system.

3. The driving apparatus as claimed in claim 1, wherein the threshold of the rotation speed for the generator is when angular speed of rotor of the generator is close to or the same as angular speed of the engine.

4. The driving apparatus as claimed in claim 2, wherein the threshold of the rotation speed for the generator is when angular speed of rotor of the generator is close to or the same as angular speed of the engine.

5. The driving apparatus as claimed in claim 1, wherein when the control circuit detects a signal indicating that the power stored in the battery is lower than a threshold, the control circuit enables the battery to provide power to operate the generator.

6. The driving apparatus as claimed in claim 2, wherein when the control circuit detects a signal indicating that the power stored in the battery is lower than a threshold, the control circuit enables the battery to provide power to operate the generator.

7. The driving apparatus as claimed in claim 2, further comprising:
a first cooling fan motor, electrically connected to the control circuit, the first cooling fan motor further comprising a first cooling fan;
a second cooling fan motor, electrically connected to the control circuit, the second cooling fan motor further comprising a second cooling fan;
an engine cooling water tank system having a first temperature sensor, the first temperature sensor electrically connected to the control circuit; and
a compressor cooling system having a second temperature sensor, the second temperature sensor electrically connected to the control circuit;
wherein when the first temperature sensor and the second temperature sensor senses respectively the temperature of the engine cooling water tank system and temperature of the compressor cooling system being lower than a threshold, the control circuit does not activate the first cooling fan motor or the second cooling fan motor; otherwise, the control circuit activates the first cooling fan motor or the second cooling fan motor.

8. The driving apparatus as claimed in claim 7, wherein the rotation speed of the first cooling fan motor or the second cooling fan motor after activation can be configured to be adjustable according to the temperature sensed by the first temperature sensor or the second temperature sensor.
